(19) United States
(12) Patent Application Publication
(10) Pub. No.: US 2014/0222762 A1
(43) Pub. Date: Aug. 7, 2014

(54) AUTOMATED DOCUMENT ARCHIVE FOR A DOCUMENT PROCESSING UNIT

(71) Applicants: Michael F. Fallon, Tiverton, RI (US); Myles Wilde, Charlestown, MA (US); Matthew J. Adiletta, Bolton, MA (US); Thomas R. Clancy, Sterling, MA (US)

(72) Inventors: Michael F. Fallon, Tiverton, RI (US); Myles Wilde, Charlestown, MA (US); Matthew J. Adiletta, Bolton, MA (US); Thomas R. Clancy, Sterling, MA (US)

(21) Appl. No.: 13/991,735

(22) PCT Filed: Dec. 28, 2011
(86) PCT No.: PCT/US11/67511

§ 371 Date: Jun. 5, 2013

(51) Int. Cl. G06F 17/30

(52) U.S. Cl. CPC G06F 17/30073
USPC 707/665

(57) ABSTRACT

According to some embodiments, a document processing unit may receive information associated with a document to be processed. The document processing unit might comprise, for example, a printer, scanner, copier, facsimile machine, or multi-function device. The document processing unit may then automatically analyze the received information in view of at least one pre-determined archive policy. The document processing unit may then automatically determine, based on the analysis, whether to apply a policy action, associated with the pre-determined archive policy, to the processing of the document. For example, the document processing unit might automatically store a copy of the document in an archive.

### BACKGROUND OF THE INVENTION

A document processing unit may facilitate an exchange and/or collection of information.

For example, an employee may use a printer or copier to create multiple copies of a memo or report to be distributed to other employees of the company. As another example, a person might use a scanner to capture images of bills, receipts, and the like for tax purposes.

In some cases, a person or business might establish an archive rule or policy to retain information. For example, copies of documents related to a certain financial transaction (e.g., a corporate acquisition or merger) might need to be retained for a pre-determined period of time to comply with governmental regulations. Other types of documents that may need to be retained might be associated with, for example, medical records, educational transcripts, and/or legal documents.

To ensure that documents are retained, a company policy handbook might let employees know that certain types of documents need to be stored, for example, in company archive (e.g., on an archive server). Even with such an approach, however, employees might forget the policy or mistakenly store copies of documents in a wrong location (e.g., making it difficult to later retrieve the information). Thus, it can be very difficult to monitor and control the archiving of information, especially when a relatively large number of people, documents, and/or document processing units are involved.

### BRIEF DESCRIPTION OF THE DRAWINGS

FIG. 1 is a block diagram of a system in accordance with some embodiments.

FIG. 2 is a flow diagram illustrating a method in accordance with some embodiments.

FIG. 3 illustrates a document according to some embodiments.

FIG. 4 is a block diagram of document processing unit according to some embodiments.

FIG. 5 is a portion of a tabular representation of an archive policy database in accordance with some embodiments.

FIG. 6 is an example of a document processing unit archive policy definition display according to some embodiments.

FIG. 7 is a block diagram of a document processing system according to some embodiments.

FIG. 8 illustrates a network in accordance with some embodiments.

FIG. 9 is a block diagram of a system according to some embodiments.

### DETAILED DESCRIPTION OF EXAMPLE EMBODIMENTS

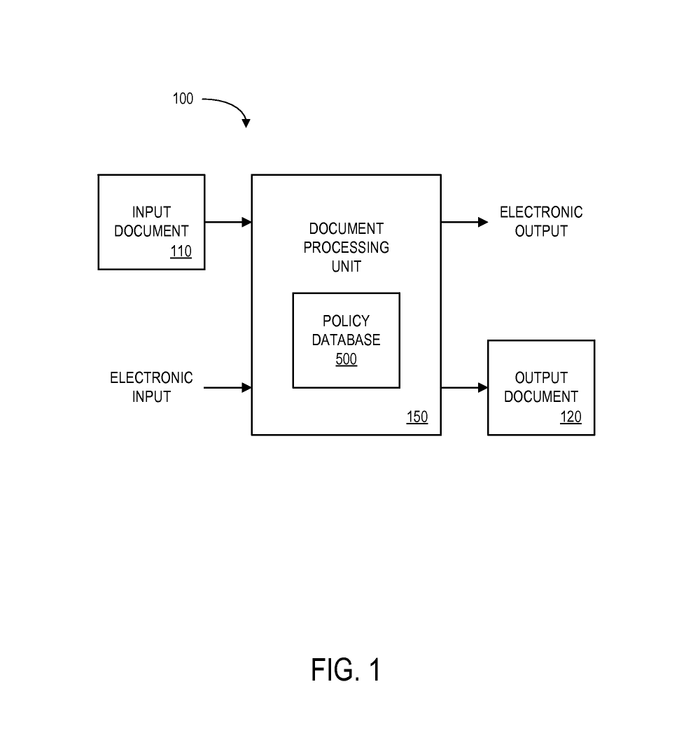

FIG. 1 is a block diagram of a system 100 that includes a document processing unit 150 in accordance with some embodiments. The document processing unit 150 may facilitate a collection and/or exchange of information. The document processing unit 150 might comprise a scanner that receives a paper input document 110 and creates an electronic output version (e.g., a bitmap image) of that document 110. As another example, the document processing unit 150 might comprise a printer that receives an electronic input (e.g., from a remote networked computer) and prints a paper output document 120. As still other examples, the document processing unit 150 might comprise a copier (e.g., that receives a paper input document 110 and generates an identical paper output document 120) or a facsimile machine (e.g., that receives the paper input document 110 and transmits a signal via a telephone line to reproduce the document at a remote location).

Note that it may be desirable to retain information that is collected or created via the document processing unit 150. For example, copies of documents related to a certain financial transaction (e.g., a corporate acquisition or merger) might need to be retained for a pre-determined period of time to comply with governmental regulations. Other types of documents that may need to be retained might be associated with, for example, medical records, educational transcripts, and/or legal documents.

To ensure that documents are retained, a company policy handbook might let employees know that certain types of documents need to be stored, for example, in company archive (e.g., on an archive server). Even with such an approach, however, employees might forget the policy or mistakenly store copies of documents in a wrong location (e.g., making it difficult to later retrieve the information). Thus, it can be very difficult to monitor and control the archiving of information, especially when a relatively large number of people, documents, and/or document processing units 150 are involved.

Accordingly, a method and mechanism to efficiently, accurately, and automatically help ensure compliance with these types of archive policies may be provided in accordance with some embodiments described herein. In particular, the document processing unit 150 of FIG. 1 includes a policy database 500 that may store one or more policy rules associated with the copying and/or creation of input documents 110 and output documents 120. For example, the policy database 500 might store information indicating that all documents printed by the document processing unit 150 should be searched to determine if the document includes the phrase “Tax Deductable.” When the phrase is detected, the document processing unit 150 inform the user who is printing the document that the phrase has been detected and ask if he or she wants a copy of the document to be stored in an automatically determined electronic folder. Only after the user confirms that he or she wants to store a copy the document will the document processing unit 150 print the paper output document 120 and store a copy of the document in the electronic folder (e.g., either local to the document processing unit 150 or in a remote archive storage unit). According to other embodiments, a copy of the document might be stored automatically without asking the user.

Note that FIG. 1 represents a logical architecture according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the document processing unit 150, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

All systems and processes discussed herein may be embodied in program code stored on one or more non-transitory computer-readable media. Such media may include, for example, a floppy disk, a CD-ROM, a DVD-ROM, magnetic tape, solid state Random Access Memory (“RAM”) or Read Only Memory (“ROM”) storage units. Embodiments are therefore not limited to any specific combination of hardware and software.

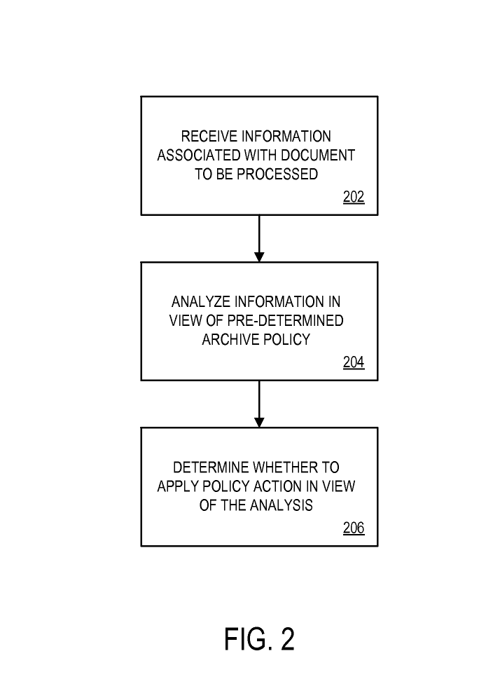

FIG. 2 is a flow diagram of a process 200 that might be associated with the document processing unit 150 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At 202, a “document processing unit” may receive information associated with a document to be processed. As used herein, the phrase “document processing unit” might refer to, for example, a printer, a scanner, a copier, a facsimile machine, and/or a multi-function document processing unit (e.g., that acts as both a printer and a copier).

At 204, the document processing unit may “automatically” analyze the received information in view of at least one pre-determined “archive policy.” As used herein, an action may be “automatic” if it requires little or no human intervention. Moreover, as used herein the phrase “archive policy” may refer to, for example, any rule that may be applied to the processing of documents, such as a rule associated with the detection of particular words or phrases. For example, a business might want to store all documents that are associated with a particular governmental contract. As still another example, an educational institution might want to store all documents related to students. Note that any archive policy described herein might be associated with a keywords, a text search, a pattern search (e.g., looking for a sequence of numbers arranged “XXX-XX-XXXX” where X is a numeric character to detect potential Social Security numbers), an Optical Character Recognition (“OCR”) analysis, an Intelligent Character Recognition (“ICR” process), and/or an image analysis (e.g., looking for a watermark or bar code associated with a particular type of product).

According to some embodiments, an archive policy might be associated with detecting a presence of a date and time (e.g., retaining documents associated with a particular time period). Note that instead of looking for and detecting certain types of material, an archive policy might be associated with detecting missing information. For example, an archive policy might note that a document is missing copyright information (e.g., “Materials Copyrighted 2015©”) or an indication that a word or phrase is trademarked (e.g., with a “®” or “™” symbol) and store copies of those documents in an archive.

At 206, the document processing unit may automatically determine, based on the analysis of 204, whether or not to apply a policy “action,” associated with the pre-determined archive policy, to the processing of the document. As used herein the phrase “policy action” may refer to, for example, automatically storing a copy of the document in an archive. For example, a printer may simply decide that all documents that include the words “receipt” or “invoice” will be automatically copied to an archive. According to other embodiments, a policy action may refer to a determination of an appropriate storage location (e.g., a particular server, database, or electronic folder) for a document. For example, if a document included the words “TOP SECRET” near the top margin, a copier might automatically encrypt an image of the document and store the encrypted copy of the document in a secure archive server.

As other examples, the policy action might be associated with an automatic generation of file name. For example, a printer might detect the name of a company in a document being printed and automatically store a copy of the document in an archive using a file name of “PR_Info_xx/xx/xxxx.yy” (where xx/xx/xxxx represents the date the document was printed and yy incrementally represents the number of times the archive rule was triggered on that particular day).

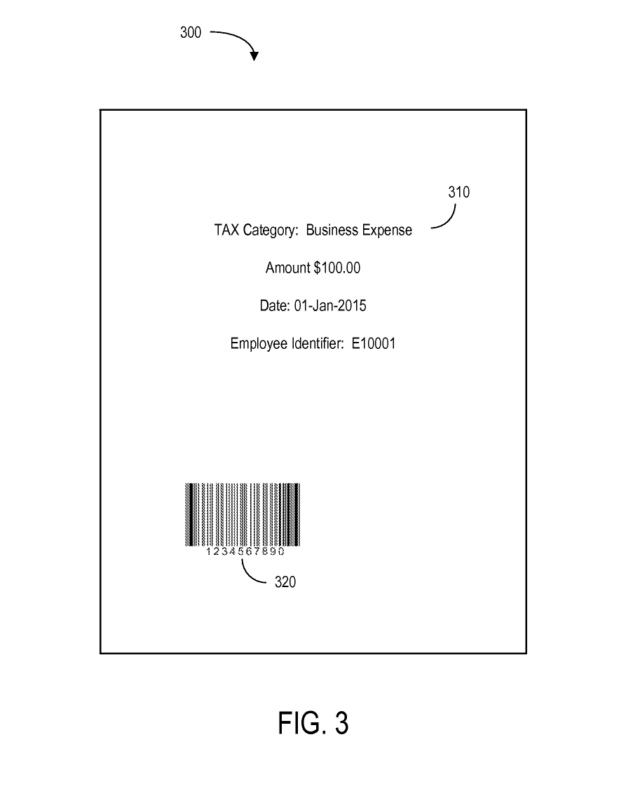

FIG. 3 illustrates a document 300 according to some embodiments. In this example, an OCR process might analyze the document and detect that it potentially contains information that may be needed when filing a tax return (e.g., because the phrase “TAX Category: Business Expense” 310 was detected). In this case, a policy action might automatically save a copy of the document in an electronic folder named “E10001” based on the Employee Identifier. Similarly, a document processing unit might look for a bar code 320 or any other type of information.

According to some embodiments, the application of an archive policy may be based at least in part on a user identifier. For example, a user might enter his or her employee identifier into a copier. In this case, different policies might be applied to different employees. For example, copies of documents scanned by a supervisor might be automatically saved while documents scanned by other employees are not. Note that the user identifier might be based on, for example, a communication between a document processing unit and a user device, such as a user's smartphone, Radio Frequency IDentifier (“RFID”) keychain, or employee card with a magnetic strip. According to other embodiments, biometric information (e.g., a fingerprint) or facial recognition process may be used to determine a user identifier. Note that application of an archive policy may be based on a user's title or role in a company. For example, copies of documents printed by a person working in human resources department might be automatically archived while documents printed by other employees are not.

According to some embodiments, the application of an archive policy may be based at least in part on a processing function type. For example, a policy might indicate that a certain type of document should automatically be saved in an archive when it is printed but not when it is sent via facsimile.

Note that in the example of FIG. 1, the pre-determined archive policy is retrieved from the policy database 500 stored local to the document processing unit 150. In this case, the policy database 500 might be installed by an administrator and/or may be automatically updated when needed or on a periodic basis (e.g., each night).

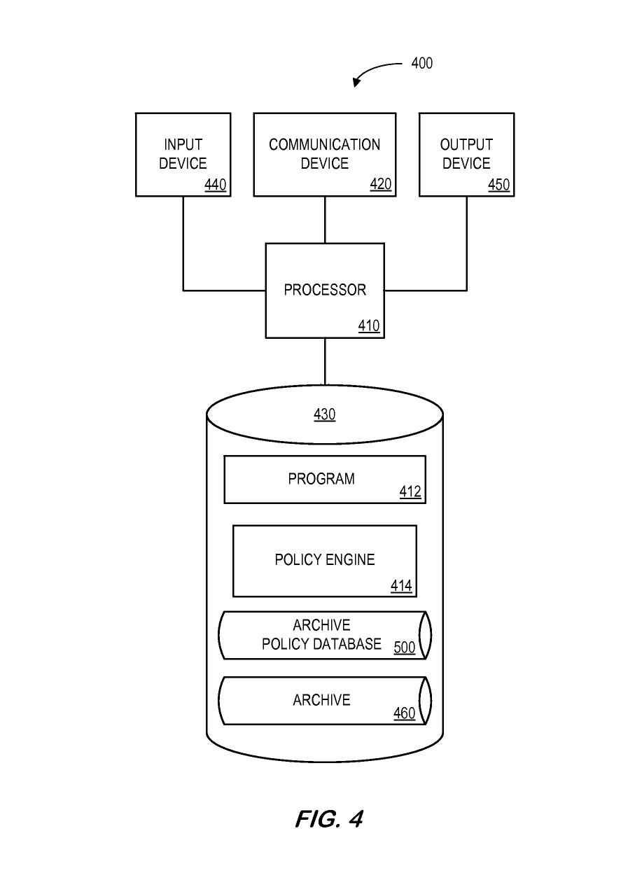

FIG. 4 is a block diagram overview of a document processing system 400 according to some embodiments. The document processing system 400 may be, for example, associated with the system 100 described with respect to FIG. 1. The document processing system 400 comprises a processor 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more remote computers, servers, or facsimile machines. The document processing system 400 further includes an input device 440 (e.g., a motion sensor, touchscreen, and/or keyboard to receive information from a user who is processing a document) and an output device 450 (e.g., a computer monitor and/or printer to provide information to a user).

The processor 410 communicates with a storage device 430. The storage device 430 may comprise any appropriate information storage device, including combinations of magnetic storage devices (e.g., a hard disk drive), optical storage devices, and/or semiconductor memory devices. The storage device 430 stores a program 412 and/or policy engine 414 for controlling the processor 410. The processor 410 performs instructions of the programs 412, 414, and thereby operates in accordance with any of the embodiments described herein. For example, the processor 410 may receive information associated with a document to be processed. The processor 410 may then automatically analyze the received information in view of at least one pre-determined archive policy. The processor 410 may then automatically determine, based on the analysis, whether to apply a policy action, associated with the pre-determined archive policy, to the processing of the document. For example, the processor 410 might automatically save a copy of a document in an archive 460.

The programs 412, 414 may be stored in a compressed, uncompiled and/or encrypted format. The programs 412, 414 may furthermore include other program elements, such as an operating system, a database management system, and/or device drivers used by the processor 410 to interface with peripheral devices.

As used herein, information may be “received” by or “transmitted” to, for example: (i) the document processing system 400 from another device; or (ii) a software application or module within the document processing system 400 from another software application, module, or any other source.

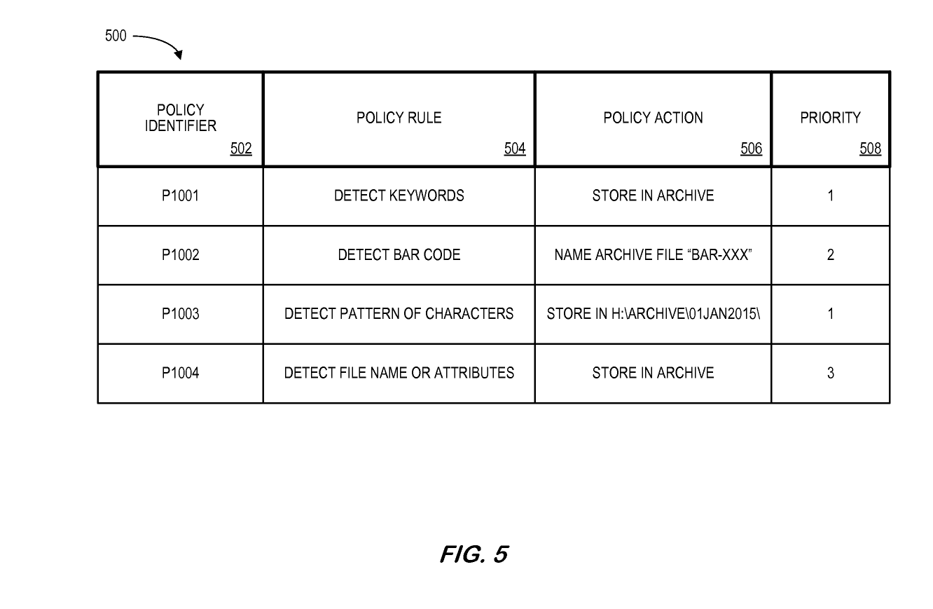

In some embodiments (such as shown in FIG. 4), the storage device 430 stores an archive policy database 500 (described with respect to FIG. 5) and the archive 460. An example of a database that may be used in connection with the document processing system 400 will now be described in detail with respect to FIG. 5. Note that the database described herein is only one example, and additional and/or different information may be stored therein. Moreover, various databases might be split or combined in accordance with any of the embodiments described herein. Referring to FIG. 5, a table is shown that represents the archive policy database 500 that may be stored at the document processing system 400 according to some embodiments. The table may include, for example, entries identifying policies that may be applied to document processing. The table may also define fields 502, 504, 506, 508 for each of the entries. The fields 502, 504, 506, 508 may, according to some embodiments, specify: a policy identifier 502, a policy rule 504, a policy action 506, and a priority 508. The information in the policy database 500 may be created and updated, for example, based on data received from an administrator.

The policy identifier 502 may be, for example, a unique alphanumeric code identifying a policy that is to be applied to a document being processed. The policy rule 504 may define the ways in which a document is to be analyzed. For example, the policy rule 504 might indicate that Social Security numbers should be detected (e.g., by looking for certain patterns or by matching values within another database) or that keywords should be detected (e.g., looking for student names). The policy action 506 may indicate one or more tasks that will be executed when the policy rule 504 is satisfied. For example, the policy action 506 might indicate that a copy of a document should be stored in archive, a file name should be generate, and/or specify where a copy of the document should be stored. The priority 508 might help a document processing unit determine which policy action 506 should be performed when multiple policy rules 504 are satisfied simultaneously.

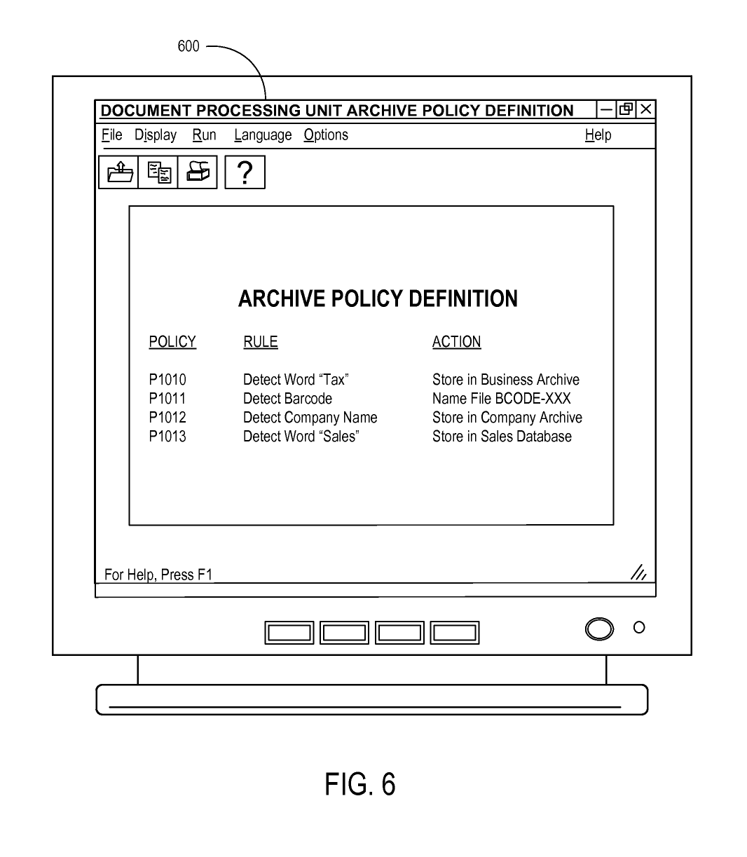

The policy rules 504 and policy actions 506 may be defined, reviewed, and/or adjusted by an administrator and/or users of a document processing unit. For example, FIG. 6 illustrates a document processing unit archive policy display 600 in accordance with some embodiments.

The display 600 may, for example, comprise a sequential list of archive policies along with one or more rules and/or actions associated with that policy. According to some embodiments, selection of a policy may result in a display of all documents that have been archived based on that policy (and where those documents are stored).

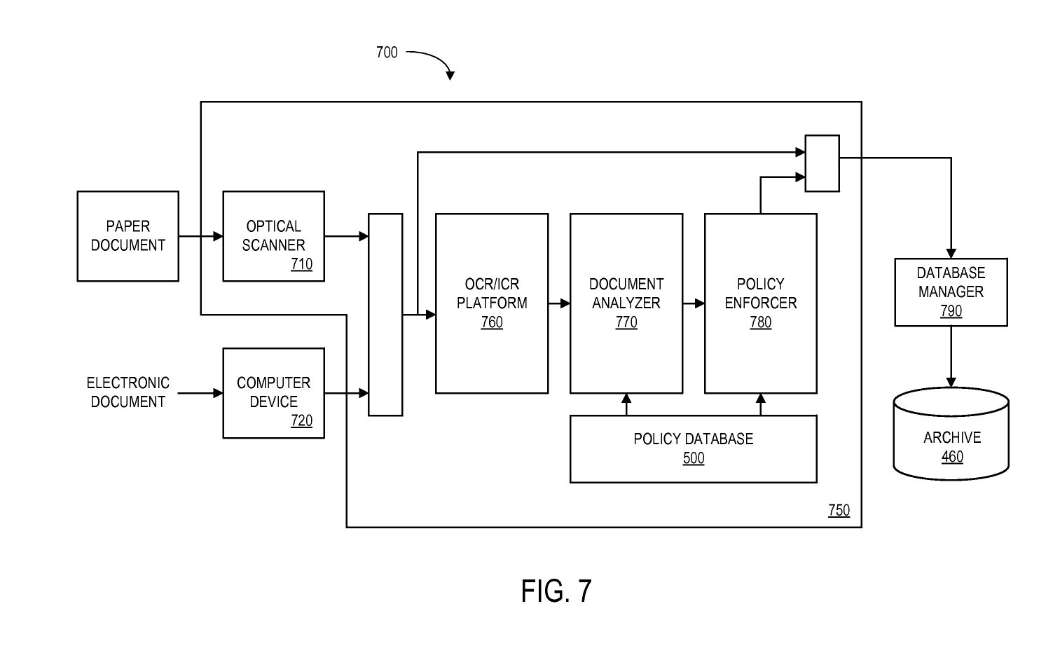

Note that embodiments described herein might be implemented using any number of different architectures. FIG. 7 is a block diagram of a document processing system 700 according to some embodiments. In particular, the system 700 may enable a document processing unit 750, such as a printer, copier, fax machine, scanner, and/or multi-function device analyze documents and enforce policies based on content. The document processing unit 750 may, for example, receive a paper document via an optical scanner 710 and/or receive an electronic document via a computer device 720 (e.g., a personal computer or server).

According to some embodiments, the document processing unit 750 includes an OCR/ICR platform 760. The OCR/ICR platform 760 may, for example, detect handwritten, typewritten, or printed text in a scanned document and output the data in a machine-encoded text that a document analyzer 770 may read and interpret. Note that paper documents might be input to the document processing unit 750 via th optical scanner 110, and electronic documents may be sent to the document processing unit 750 via a computer device 720, such as computer network. The input format of these documents may not be consistent with the format required by various components of the document processing system 750. As a result, a document format converter may convert an input document format into a format that is consumable by the components of the document processing system 750 (e.g., the OCR/ICR platform 160).

The document processing unit 750 may also include a policy database 500 according to some embodiments. The policy database 500 may be configured and maintained by a system administrator and contain a set of rules, such as rules associated with a presence or lack of presence of particular content. For example, a rule might detect the presence of the word “Invoice” in a document or a document name. As another example, a rule might detect the presence of Social Security numbers in a document. The policy database 500 may further define actions to take when rule violations are detected. For example, the actions might be associated with storing a copy of the document in an archive, determining an appropriate location for the document, and/or determining an appropriate file name for the document. The policy database 500 may also include a priority level to be used when multiple rules are triggered.

The document processing unit 750 may also include the document analyzer 770 according to some embodiments. The inputs to the document analyzer 770 may be the policy rules as well as the document being processed. The document analyzer 770 may then evaluate each rule in the context of the current document and output a result to a policy enforcer 780. According to some embodiments, there are two classes of analysis that may be processed by the document analyzer 770: (i) a text based analysis, and (ii) an image based analysis. The text based analysis may employ techniques such as OCR algorithms and ICR (e.g., to detect handwriting). The image based analysis might, for example, search for specified images in the document.

According to some embodiments, the document processing unit 750 may also include the policy enforcer 780. The inputs to the policy enforcer 780 may be the output of the document analyzer 770 and the action list and priority levels from the policy database 500. The policy enforcer 780 may be responsible for deciding one or more final actions taken by the system 700 (such as to create a file name, select a storage location, automatically copy a document, etc). The policy enforcer 780 may make this decision based on the results generated by the document analyzer 770 and the priority of each rule. That is, a plurality of pre-determined archive policies are each associated with a policy priority, and actions actually performed by the document processing system 750 may be further based on those policy priorities.

Consider, for example, a situation where the document analyzer 770 detects two events that each have an associated action required by the policy enforcer 780. The first event has an associated low priority action of creating a file name using a first rule and the second event has an associated high priority action of creating a file name using a second rule. In this case, the policy enforcer 780 may decide to not perform the actions associated with the first event (and name the file in accordance with the second rule). According to other embodiments, two files might be created instead.

The policy enforcer 780 may arrange for a copy of the document to be automatically stored into an archive database 460 via a database manager 790. The database manager 790 might comprise, for example, a Database Management System (“DBMS”) that facilitates the storage, maintenance, and/or access of information stored in the archive 460. The database manager 790 may also provide encrypted data storage for security as well as reliability features (e.g., storage redundancy) and/or efficiency advantages (e.g., parallel communications). According to some embodiments, the image processing unit 750 and/or database manager 790 is also associated with a user control panel. The user control panel might comprise, for example, a human interface used to support user operations, such as: (i) creating, modifying, or deleting archive policy rules, (ii) accessing information from an archive, and/or (iii) printing documents stored in the archive.

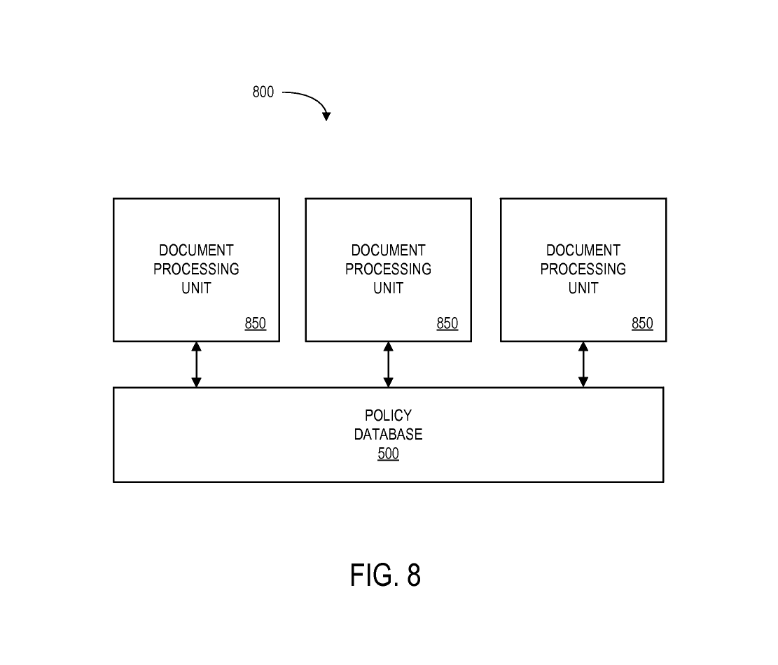

Note that in the example of FIG. 1, the pre-determined archive policy is retrieved from the policy database 500 stored local to the document processing unit 150. According to some embodiments, a pre-determined archive policy is received from a policy database stored remote from the document processing unit, and the policy database is accessed by a plurality of document processing units. FIG. 8 illustrates a network 800 in accordance with some embodiments. The network includes a single policy database 500 accessed by multiple document processing units 850. In this way, only a single entry may need to be update to change an archive policy. Moreover, consistency between the document processing units 850 may be insured. According to this embodiment, each document processing unit 850 may access the policy database 500 as needed (e.g., using a request-response model or a nightly download of policies).

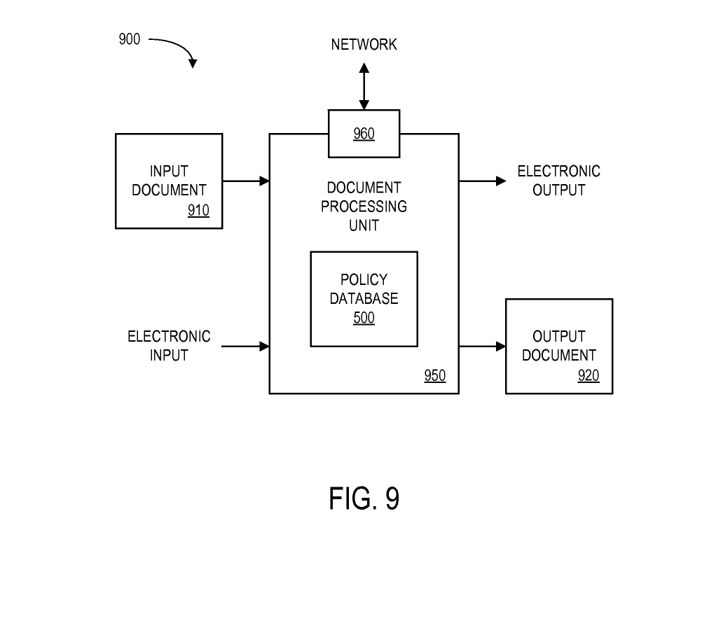

FIG. 9 is a block diagram of a system 900 according to some embodiments. The system includes a document processing unit 950 with a policy database 500 (e.g., storing at least one pre-determined archive policy and associated policy action). The document processing unit 950 may receive input documents 910 and/or create output documents 920 as appropriate. Moreover, the document processing unit 950 may: (i) receive information associated with a document to be processed, (ii) analyze the received information in view of at least one pre-determined archive policy in the policy database 500, and (iii) determine, based on this analysis, whether to apply the policy action associated with the pre-determined archive policy to the processing of the document. According to some embodiments, the document processing unit 950 further includes a network interface component 960 and may exchange data associated with the document to be processed via the network interface component 960.

Accordingly, a method and mechanism to efficiently, accurately, and automatically help ensure compliance with archive policies may be provided in accordance with some embodiments described herein.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to particular types of archive policies, note that embodiments may be associated with other types of policies. For example, an archive policy might be associated with a company's newly developed products, competitors, and/or customers. Moreover, while embodiments have been illustrated using particular ways of applying policies to documents, note that embodiments might be associated with audio and/or video information (e.g., displayed on a monitor, captured via a web video camera, and/or spoken over a telephone).

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method, comprising:
receiving, at a document processing unit, information associated with a document to be processed;
automatically analyzing, by the document processing unit, the received information in view of at least one pre-determined archive policy; and
automatically determining, by the document processing unit based on said analysis, whether to apply a policy action, associated with the pre-determined archive policy, to the processing of the document.

2. The method of claim 1, wherein the document processing unit comprises at least one of: (i) a printer, (ii) a scanner, (iii) a copier, (iv) a facsimile machine, or (v) a multi-function document processing unit.

3. The method of claim 1, wherein the pre-determined archive policy comprises a rule associated with at least one of: (i) detecting pre-determined text, (ii) detecting a watermark, or (iii) detecting a bar code.

4. The method of claim 1, wherein the policy action is associated with at least one of: (i) storing a copy of the document in an archive, (ii) determining an appropriate location for the document, or (iii) determining an appropriate file name for the document.

5. The method of claim 1, wherein said determining is further based on at least one of: (i) a user identifier, or (ii) a processing function type.

6. The method of claim 1, wherein said analysis is associated with at least one of: (i) keywords, (ii) a text search, (iii) a pattern search, (iv) an optical character recognition analysis, (v) or an image analysis.

7. The method of claim 1, wherein a plurality of pre-determined archive policies are each associated with a policy priority, and said automatic determination is further based on the policy priorities.

8. The method of claim 1, wherein the pre-determined archive policy is retrieved from a policy database stored local to the document processing unit.

9. The method of claim 1, wherein the pre-determined archive policy is received from a policy database stored remote from the document processing unit, wherein the policy database is accessed by a plurality of document processing units.

10. A non-transitory computer-readable storage medium having stored thereon instructions that when executed by a machine result in the following:
receiving, at a document processing unit, information associated with a document to be processed;
automatically analyzing, by the document processing unit, the received information in view of at least one pre-determined archive policy; and
automatically determining, by the document processing unit based on said analysis, whether to apply a policy action, associated with the pre-determined archive policy, to the processing of the document.

11. The medium of claim 10, wherein the document processing unit comprises at least one of: (i) a printer, (ii) a scanner, (iii) a copier, (iv) a facsimile machine, or (v) a multi-function document processing unit.

12. The medium of claim 10, wherein the pre-determined archive policy comprises a rule associated with at least one of: (i) detecting pre-determined text, (ii) detecting a watermark, or (iii) detecting a bar code.

13. The medium of claim 10, wherein the policy action is associated with at least one of: (i) storing a copy of the document in an archive, (ii) determining an appropriate location for the document, or (iii) determining an appropriate file name for the document.

14. The medium of claim 10, wherein said determining is further based on at least one of: (i) a user identifier, or (ii) a processing function type.

15. The medium of claim 1, wherein said analysis is associated with at least one of: (i) keywords, (ii) a text search, (iii) a pattern search, (iv) an optical character recognition analysis, (v) or an image analysis.

16. An apparatus, comprising:
a policy database storing a pre-determined archive policy and associated policy action; and
a document processing unit, coupled to the policy database, to: (i) receive information associated with a document to be processed, (ii) analyze the received information in view of at least one pre-determined archive policy in the policy database, and (iii) determine, based on said analysis, whether to apply the policy action associated with the pre-determined archive policy to the processing of the document.

17. The apparatus of claim 16, wherein the document processing unit comprises at least one of: (i) a printer, (ii) a scanner, (iii) a copier, (iv) a facsimile machine, or (v) a multi-function document processing unit.

18. The apparatus of claim 16, wherein the pre-determined archive policy comprises a rule associated with at least one of: (i) detecting pre-determined text, (ii) detecting a watermark, or (iii) detecting a bar code.

19. The apparatus of claim 16, wherein the policy action is associated with at least one of: (i) storing a copy of the document in an archive, (ii) determining an appropriate location for the document, or (iii) determining an appropriate file name for the document.

20. A system, comprising:
a network interface component;
a policy database storing a pre-determined archive policy and associated policy action; and
a document processing unit, coupled to the network interface component and policy database, to: (i) receive information associated with a document to be processed, (ii) analyze the received information in view of at least one pre-determined archive policy in the policy database, and (iii) determine, based on said analysis, whether to apply the policy action associated with the pre-determined archive policy to the processing of the document, wherein the document processing unit is further to exchange data associated with the document to be processed via the network interface component.

21. The system of claim 20, wherein the document processing unit comprises at least one of: (i) a printer, (ii) a scanner, (iii) a copier, (iv) a facsimile machine, or (v) a multi-function document processing unit.

22. The system of claim 20, wherein the pre-determined archive policy comprises a rule associated with at least one of: (i) detecting pre-determined text, (ii) detecting a watermark, or (iii) detecting a bar code.

23. The system of claim 20, wherein the policy action is associated with at least one of: (i) storing a copy of the document in an archive, (ii) determining an appropriate location for the document, or (iii) determining an appropriate file name for the document.
